(19) United States
(12) Patent Application Publication
(10) Pub. No.: US 2011/0054690 A1
(43) Pub. Date: Mar. 3, 2011

(54) ELECTRO-MECHANISM FOR EXTENDING THE CAPABILITIES OF BILATERAL ROBOTIC PLATFORMS AND A METHOD FOR PERFORMING THE SAME

(76) Inventor: Ehud Gal, Reut (IL)

(21) Appl. No.: 12/860,955

(22) Filed: Aug. 23, 2010

Related U.S. Application Data
(60) Provisional application No. 61/236,555, filed on Aug. 25, 2009.

(51) Int. Cl. G05B 15/00; H01Q 3/02; H01Q 1/32

(52) U.S. Cl. 700/258; 343/757; 343/713

(57) ABSTRACT

The present invention discloses an electro-mechanism for extending the capabilities of a bilateral robotic platforms and a method for performing the same. The electro-mechanism includes an attitude sensor to provide indication of the side over which a bilateral robotic platform operates and an actuator to tilt a mast to an upright position with respect to the ground in order to maximize the performance of the components integrated therewith. The electro-mechanism also provides means to elevate an environmental sensor to provide a superior position for information gathering with respect to the bilateral robotic platform.

This patent application claims the benefit of U. S. Provisional Patent Application No. 61/236,555 filed Aug. 25, 2009.

### FIELD AND BACKGROUND OF THE INVENTION

The present invention is related to the field of robotics; more specifically the invention is related to the field of electro-mechanisms for extending the capabilities of bilateral robotic platforms.

The art of robotics has increasingly developed throughout the years, and many solutions have been offered by the art in order to overcome the various challenges inherent in the robotics field. Solutions offered by the art are usually customized to the requirements for which a robotic platform is designed.

Bilateral operation capability in the field of robotics means the ability of a robotic platform to operate on 2 different sides with respect to the architecture of the robotic platform. This capability is sometimes referred to in the art as: double side, dual side, or inversion. Bilateral robotic platforms are usually characterized by their ability to operate at an operational scene regardless to the side on which they are deployed. This capability is especially essential when robotic platforms are to be thrown into hazardous environments and when robotic platforms are required to overcome obstacle which may cause them to flip over.

The following paragraphs describe a few examples of bilateral platforms that are published in the art:

International application WO/2008135978 to Gal (Gal '978) teaches a robotic mobile platform vehicle that can be thrown into hostile or hazardous environments for gathering information and transmitting that information to a remotely located control station. Gal '978 addresses the bilateral capabilities challenge by using a symmetric platform designed to operate on either side without engaging dedicated mechanical mechanisms to flip the entire platform over or to tilt its sensors without steering the entire platform. Gal '978 achieves this bilateral capability by making the platform and its sensors vertically symmetrical. In order to achieve this symmetry Gal '978 teaches directing the sensors horizontally instead of tilting the sensors towards the desired region of interest which is usually elevated relatively to the low profile platform. The result is that a large portion of the visual frame is wasted on parts of the view that are of no interest to the operator.

U.S. published patent application no. 2008/0277172 to Ben-Tzvi et al. (BenTzvi '172) describes a bilateral tracked platform with a rotating articulated manipulator arm that serves both for locomotion and for manipulation. The manipulator arm BenTzvi '172 is designed for maneuverability and for manipulation. BenTzvi '172 does not suggest use of the manipulative arm for non-manipulative functions such as reconnaissance and orientation of the robot (for example by placing the main sensors of the robot on the manipulative arm). Similar to Gal '978, BenTzvi '172 locates sensors on the frame of the platform. In order to allow bilateral functionality, the sensors are located on the midline of the platform and directed horizontally. Thus the low profile platform's sensors can not focus on the common region of interest a few meters above the platform and the platform cannot raise its sensors to see over obstacles. This limits the view of the operator who must look at the operational scene from near the ground. Furthermore, the main sensors of BenTzvi '172 are not synchronized with the manipulator arm. For example, if the manipulator arm is acting upon some object behind or above the platform, a secondary set of sensors will need to be employed.

A major challenge associated with many robotic platforms is maintaining proper communication with the platform at a remote location. The performance of communication means (e.g., wireless receivers, transceivers or any combination thereof) is usually very sensitive to their position relatively to the ground. In order to maximize the performance of the communication means, it often advantageous to have an antenna located as high as possible above the ground. For a bilateral platform designed to flip over during operation, it is difficult to supply a raised antenna and good communication performance.

U.S. Pat. No. 6,522,303 to West et al. (West '303) discloses an air droppable bilateral LAN. The LAN of West '303 includes a slot antenna located on the midline of a two-sided self-orienting casing (that is designed to orient right-side-up or up-side-down, but not on its side). The antenna of West '303 suffers from at least two disadvantages: 1) the antenna is close to the ground and therefore poorly suited for long distance communication and for communication over obstacles; 2) the antenna requires that the casing be properly oriented. These disadvantages limit the LAN of West '303 to local communication and to a stationary unilateral platform. Such a solution will not work for a mobile robot serving in remote locations.

The above prior art bilateral platforms can only offer minimal communication performance for bilateral operation. Such solutions are inefficient energy wise and compromise the performance of the communication means. Therefore, none of the above cited bilateral platforms offers a solution to maintaining optimal antenna inclination for communication by a bilateral robotic platform at a remote location that changes operation attitude during operation.

If no proper measurements are taken to ensure continuous effective operation of the communication means during flip-over of the robotic platforms, then a flip-over of the robotic platform will cause the antennas associated with the communication means to be turned upside down along with the robotic platform and to face the opposite direction than the direction for which they were originally designed to operate. As a result, the performance of the communication means will be significantly reduced, in a manner which may jeopardize effective control over the robotic platform.

U.S. Pat. No. 6,292,147 to Ham (Ham '147) discloses a dual swivel-mounted internal GPS antenna for a mobile phone. The antenna of Ham '147 solves the problem of maintaining optimal inclination, but the location and size of the antenna is limited by the location and size of the container. Thus, the antenna of Ham '147 is well suited to receiving GPS signals (from commercial satellites) but is not adequate for a robotic vehicle that needs to transmit with limited power and may have to keep in contact with an earthbound controller who may be obscured by low-lying obstacles.

U.S. Pat. No. 4,292,861 to Thornhill et al. (Thornhill '861) discloses an air-droppable omni-lateral instrument for scientific measurements in remote locations. Thornhill '861 discloses a deployable self-orienting antenna to facilitate communication with the instrument. Nevertheless, the instrument of Thornhill '861 cannot be reoriented during operation and is not configured for operating and constantly reorienting while mounted on a moving vehicle, for withstanding forces associated with the motion of the vehicle and particularly for overturning.

U.S. Published Application 2006/0071867 to Quagliaro (Quagliaro '867) discloses a space vehicle having a deployable self-orienting antenna for maintaining communication with an aerial platform. The vehicle of Quagliaro '867 is not capable of bilateral operation and the antenna of Quagliaro '867 has a very limited range of movement and, once deployed, the antenna of Quagliaro '867 is fragile and would not survive a vehicle overturning.

Another challenge associated with bilateral robotic platforms is capturing intuitive imagery information. Because many of the bilateral robotic platforms have a relatively low profile, their imaging sensors are usually close to the ground and therefore capture a disadvantageous perspective (from the low perspective one can not see the faces of nearby standing objects, e.g., people; one cannot see the ground even at a distance of more than a few meters; one cannot see over even low objects).

In the prior art, periscopes have been suggested for solving this perspective problem. For example U.S. Pat. No. 5,495,370 to Tuffen (Tuffen '370) provides a periscope for surveillance from a parked vehicle. Nevertheless, a periscope is not suitable for bilateral operation and Tuffen '370 does not suggest a mechanism for bilateral operation or changing of the angle of operation at all.

None of the above cited art discloses or suggests a mechanism that makes possible self reorientation of sensors and antennae for a bilateral platform that gives optimal vantage point and communication performance.

It is therefore desirable to provide an electro-mechanism for bilateral robotic platforms which provides an elevated point of view to imaging sensors associated with the electro-mechanism, regardless to the side on which the bilateral robotic platform operates.

It is therefore desirable to provide an electro-mechanism for a bilateral robotic platform which extends the performance of its communication means, regardless to the side on which the bilateral robotic platform operates.

It is therefore desirable to provide an electro-mechanism for bilateral robotic platforms which can be utilized to provide stereoscopic imaging.

It is therefore desirable to provide an electro-mechanism for bilateral robotic platforms which support antenna diversity techniques.

It is therefore desirable to provide an electro-mechanism for bilateral robotic platforms which incorporates additional reconnaissance sensors at an enhanced position relatively to the ground and to the bilateral robotic platforms.

It is therefore desirable to provide an electro-mechanism for bilateral robotic platforms which is automatically adjusted to maximize the performance of the components associated therewith during obstacle overcoming and during different slopes of the operational terrain.

It is therefore desirable to provide an electro-mechanism for bilateral robotic platforms which can be utilized as a scanning or as an investigating imaging means.

Other objects and advantages of the invention will become apparent as the description proceeds.

### SUMMARY OF THE INVENTION

Various embodiments of a device for extending the capabilities of a bilateral robotic platform are possible. The device may be capable of withstanding vehicle motion, and the device may be capable of inclining to provide an improved vantage point to a sensor or an antenna during bilateral operation.

An embodiment of a device for communication of a bilateral robotic platform may include a mast configured for inclining over a range of at least 180 degrees with respect to a frame of the bilateral robotic platform. The device may also include an antenna for receiving a control signal, and an attitude sensor for sensing an attitude of the frame of the robotic platform. The inclining may be adjusted according to an output of the attitude sensor. The inclining may raise the antenna and the inclining may be adjusted in response to a change in the attitude of the robotic platform.

An embodiment of a device for communication of a bilateral robotic platform may also include an environmental sensor mounted on the mast.

In an embodiment of a device for communication of a bilateral robotic platform, the environmental sensor may include an imaging sensor, a light source, a microphone, a light detector, a Global Positioning System (GPS) receiver, a range detector, a laser designator, a directional antenna or an omni-directional antenna.

In an embodiment of a device for communication of a bilateral robotic platform, the antenna may include a radio antenna, a microwave antenna, an infrared signal detector, an ultraviolet signal detector, a directional antenna or an omni-directional antenna.

In an embodiment of a device for communication of a bilateral robotic platform, the mast may be further configured for adjusting the angle of inclining to optimize reception of the antenna.

An embodiment of a device for extending the capabilities of a bilateral robotic platform may include a mast configured for inclining over a range of at least 180 degrees with respect to a frame of the bilateral robotic platform. The device may also include a first environmental sensor, and an attitude sensor for sensing an attitude of the frame. The mast may be configured for inclining according to an output of the attitude sensor. The inclining may raise the first environmental sensor and the mast may be configured for adjusting the angle of inclination in response to a change in the attitude of the frame of the bilateral robotic platform.

In an embodiment of a device for extending the capabilities of a bilateral robotic platform, a portion of the mast may be flexible.

In an embodiment of a device for extending the capabilities of a bilateral robotic platform, the attitude sensor may include a tilt detector, an inclinometer, a vertical gyro, an acceleration sensor, an inertial sensor or a magnetometer.

In an embodiment of a device for extending the capabilities of a bilateral robotic platform, the mast may be extendible.

An embodiment of a device for extending the capabilities of a bilateral robotic platform may further include a second environmental sensor mounted on a second mast. The field of view of the second environmental sensor may overlap the field of view of the first environmental sensor and the first environmental sensor and the second environmental may be configured to provide a stereoscopic image.

In an embodiment of a device for extending the capabilities of a bilateral robotic platform, the first environmental sensor may be configured for scanning a region.

In an embodiment of a device for extending the capabilities of a bilateral robotic platform, the first environmental sensor may include a light source, a microphone, a light detector, a Global Positioning System (GPS) receiver, a range detector, a laser designator, a directional antenna or an omni-directional antenna.

An embodiment of a device for extending the capabilities of a bilateral robotic platform may further include an antenna configured for receiving control signals.

In an embodiment of a device for extending the capabilities of a bilateral robotic platform, the antenna may be integrated into a casing of the mast.

In an embodiment of a device for extending the capabilities of a bilateral robotic platform, the mast may be configured for adjusting the angle of inclination to maximize radio reception.

In an embodiment of a device for extending the capabilities of a bilateral robotic platform, an interface between the sensor and the frame may include a wireless communication device or a slip ring.

An embodiment of a method for extending the capabilities of a bilateral robotic platform may include determining an attitude of a frame of the bilateral robotic platform using an attitude sensor and inclining a mast to raise an environmental sensor. The inclining may be in accordance with an output of the attitude sensor. The method may also include adjusting the angle of inclination according to a change in the attitude of the frame of the robotic platform.

In an embodiment of a method for extending the capabilities of a bilateral robotic platform, the inclining may be to an upright position with respect to an environmental reference.

In an embodiment of a method for extending the capabilities of a bilateral robotic platform, the inclining may be to an upright position with respect to the frame of the bilateral platform.

In an embodiment of a method for extending the capabilities of a bilateral robotic platform, the angle of inclination may be adjusted to maximize a radio reception.

### BRIEF DESCRIPTION OF THE DRAWINGS

In the drawings:

FIG. 1 schematically illustrates a perspective view of the basic components of an embodiment of an electro-mechanism for enhancing the performance of a bilateral robotic platform.

FIG. 2 schematically illustrates a perspective view of a second embodiment of an electro-mechanism for enhancing the performance of a bilateral robotic platform having a slip ring interface.

FIG. 3 schematically illustrates a perspective view of a sub mechanism utilized to tilt dual masts in an embodiment of an electro-mechanism for enhancing the performance of a bilateral robotic platform.

FIG. 4A schematically illustrates a double mast electro-mechanism for enhancing the performance of a bilateral robotic platform with masts retracted in a transition between storage mode and operational mode.

FIG. 4B schematically illustrates a double mast electro-mechanism for enhancing the performance of a bilateral robotic platform in operational mode.

FIG. 4C schematically illustrates a double mast electro-mechanism for enhancing the performance of a bilateral robotic platform in an exploring mode.

FIG. 5A schematically illustrates a side projection of a bilateral robotic platform in exploring mode utilizing an electro-mechanism to improve viewing below the platform.

FIG. 5B schematically illustrates a side projection of a bilateral robotic platform in exploring mode utilizing an electro-mechanism to improve viewing behind the platform.

FIG. 6A schematically illustrates a top projection of a dual mast bilateral platform with stereoscopic vision.

FIG. 6B schematically illustrates a top projection of a dual mast bilateral platform in a scanning mode.

FIG. 6C schematically illustrates a top projection of a dual mast bilateral platform in a scanning mode.

FIG. 7 schematically shows a perspective view of different operational positions of an electro-mechanism incorporated in a second embodiment of a bilateral robotic platform.

FIG. 8 is a flow chart illustrating a method of extending the capability of a bilateral robotic platform.

### DETAILED DESCRIPTION OF THE INVENTION

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice.

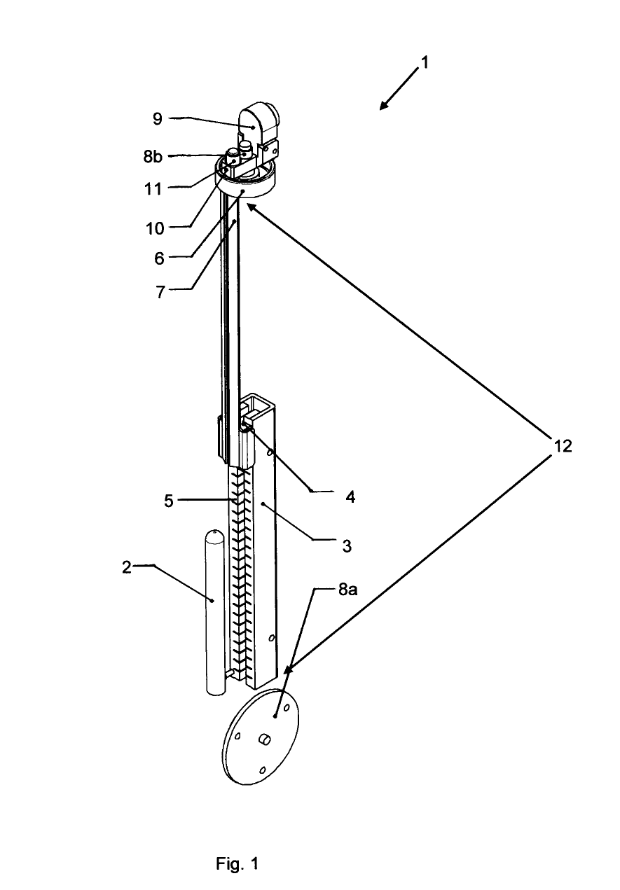

FIG. 1 schematically shows a perspective view of the basic components of an embodiment 1 of an electro-mechanism for enhancing the vantage point of bilateral robotic platforms.

Embodiment 1 includes a mast 12 made up of a linear motor 3 and an extension bar 7. An antenna 2 is connected to linear motor 3. A trolley 4 rides along a track 5 in order to extend extension bar 7. Various components are integrated on a base plate 6 at the head of extension pole 7.

In embodiment 1, in order to avoid tangling wires during mechanical movements of mast 12, a main slip ring 8a provides the interfaces between a bilateral robotic platform and linear motor 3 of embodiment 1. Such interfaces include: integration to the communication means inside the bilateral robotic platform and to the control signals which are transmitted by a remote operator therewith. In addition, such interfaces include: power supply from the bilateral robotic platform energy sources to the power components integrated into embodiment 1; data channels for transmitting control signals from antenna 2 (antenna 2 may be a radio antenna for receiving radio signals from a remote control unit or antenna 2 may be a microwave antenna infrared or ultraviolet antenna or an antenna for signals in other bands as known in the art) and from a video camera 9, to the bilateral robotic platform. A slip ring 8a enables embodiment 1 to be freely tilted with respect to the robotic platform without tangling wires. A vertical linear slip track mechanism is applied herewith, mutatis mutandis, for providing power supply and the communication channel interfaces between trolley 4 and track 5 without disruption by motion of trolley 4 along track 5. Alternatively, a simple wire connection or a flexible flat cable can be utilized or mast 12 may have a self contained power supply and wireless communication channels.

A sensor 9 is mounted to base plate 6. In embodiment 1, sensor 9 is an imaging device and particularly a high resolution video camera and a corresponding illumination means; alternatively sensor 9 may include another imaging device, for example, a FLIR or an IR camera or an X-ray, microwave, ultrasound or ultraviolet imager; alternatively sensor 9 may include a scanning sensor, such as radar or sonar; alternatively sensor 9 may include an omni-directional sensor, such as a smoke detector or a Geiger counter. Sensor 9 is mounted on a holding frame 10, which is rotated by a motor 11. Motor 11 rotates video camera 9 together with holding frame 10 and a slip ring 8b with respect to base plate 6 which remains stationary with respect to extension bar 7. Slip ring 8b enables continuous rotation of sensor 9 around the axis of extension bar 7 without tangling wires. Information acquired by the sensor 9 is transmitted through slip ring 8b to extension bar 7 and from extension bar 7 to slip ring 8a via linear motor 3 and trolley 4. From slip ring 8a, information is transmitted into an integral communication means of the bilateral robotic platform and to a remote control unit.

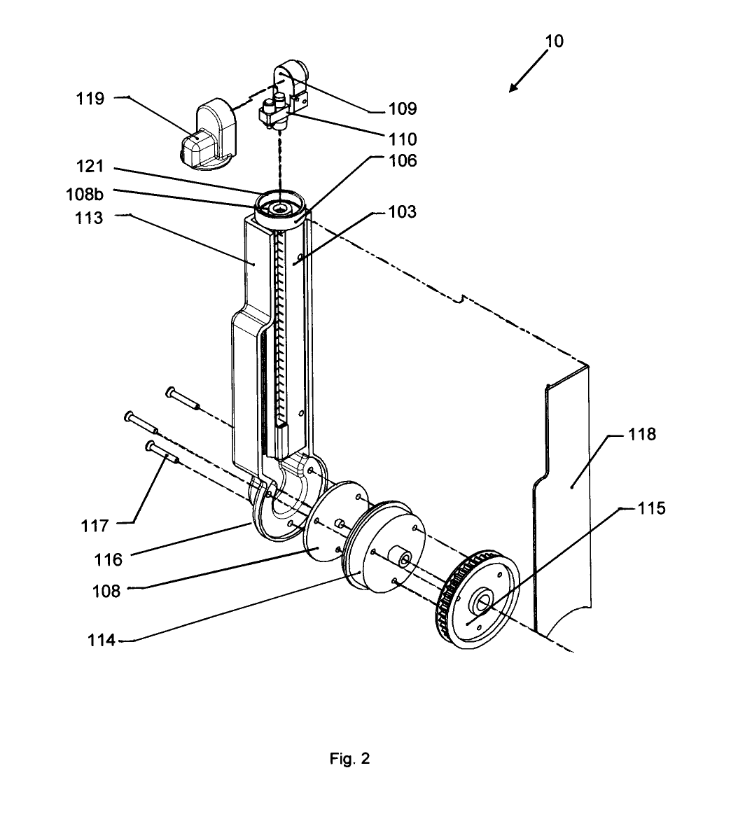

FIG. 2 schematically depicts a perspective view of the mechanism of a second embodiment 100 of an electro-mechanism for enhancing the vantage point of bilateral robotic platforms.

A housing 113 protects a linear motor 103. Housing 113 also functions as an antenna. A slip ring 108a is integrated to an auxiliary wheel 114 and to a timing wheel 115 which are connected to a housing base 116. The entire embodiment 100 rotates freely around a shaft (not shown). Bolts 117 are provided to couple the slip ring 108a to auxiliary wheel 114 and to timing wheel 115. A housing cover 118 is provided to protect a linear motor 103 and the components attached to it from the elements and from shocks which they may sustain during deployment of the bilateral robotic platform.

In embodiment 100, a top housing 119 is also provided in order to protect the components mounted to base plate 106. A slip ring 108b is utilized as an interface to an extension bar (not shown) mounted on linear motor 103 to provide power supply to the components on top of base plate 106 and to transmit information from sensor 109 to the bilateral robotic platform while providing unlimited rotation of sensor 109 and holding frame 110 with respect to base plate 106 which is fixed onto the extension bar.

The inner surface 121 of base plate 106 serves as a friction surface over which the motor and its gear are rotated.

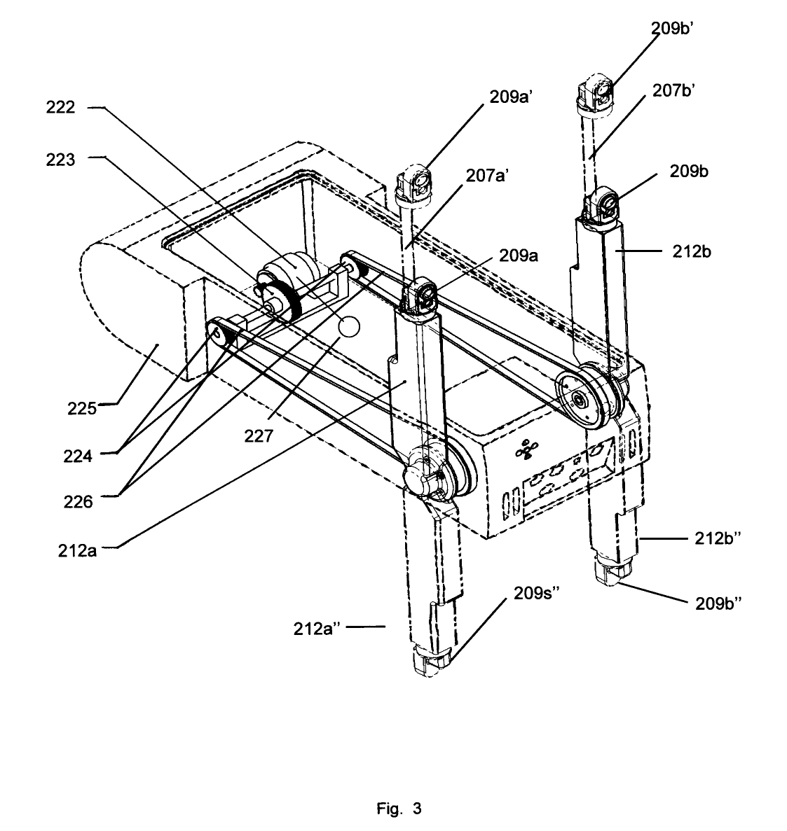

FIG. 3 schematically shows a perspective view of a tilt mechanism to control inclination of dual electro-mechanisms of embodiment 100.

In this preferred embodiment, two synchronized electro-mechanism are inclined by an actuator 222 and gear 223 which are pivotally connected to timing wheels 224 incorporated inside the rear panel 225 of a bilateral robotic platform. Timing belts 226 are wrapped over the timing wheels 224 to provide synchronized tilting of two masts, mast 212a (on the left side) and mast 212b (on the right side).

In FIG. 3, left and right masts 212a and 212b stand vertically erect giving an improved above-ground perspective to sensors 209a and 209b during operation of the bilateral robotic platform. In addition to the tilting capabilities of the electro-mechanism, which ensure efficient performance of the antenna incorporated therewith, regardless to the side on which the bilateral robotic platform operates, a linear motor enables extension of the mechanism to increase the height of the mast, in order to provide a superior position from which information can be acquired. Particularly, to further improve the vantage point, an extended position is shown in dashed outlines. In the extended position, linear motors are activated to extend extension bars 207a′ and 207b′ to further raise sensors 209a and 209b to their extended position illustrated as sensors 209a′ and 209b′

Should the bilateral robotic platform flip over during its deployment or during its maneuvering over obstacles, then an attitude sensor 227 configured to supply an environmental attitude reference (for example the direction of gravity, the direction of the horizon, the direction of the ground or movement shifts which are gathered by inertial sensors) will sense the flip-over of the bilateral robotic platform and send a command signal to actuator 222 to incline left and right masts 212a and 212b by rotating 180 degrees to new positions illustrated as masts 212a″ and 212b″ with improved vantage point position of sensors 209″ and 209b″. Thus masts 212a″ and 212b″ stand upright with respect to opposite sides of the bilateral robotic platform on which the platform operates after the roll-over, as shown by the dashed outlines.

For a low-profile robotic platform, it is important to achieve maximum antenna performance, therefore masts 212a,b are configured for inclining over a continuous range of angles. At times of poor reception, the angle of inclination of masts 212a,b is fine-adjusted either in the positive or negative direction to improve reception. Adjustment is continuous and may have an arbitrary magnitude and direction (The angle is not limited to a few preset angles, and rotation can be in either direction. In a preferred embodiment the inclination angle can be adjusted by increments of a degree or less. In an alternative embodiment the angle may be adjusted in increments of 10 degrees or less.) A feedback system and processor are provided between a radio transceiver and actuator 222 for adjusting the inclination of masts 212a,b to optimize radio reception.

For improved communication performance, in an alternative embodiment, mast 212a can be adjusted independently of mast 212b. Under conditions of limited reception in the presence of obstacles, the locations of masts 212a,b are adjusted such that an antenna associated with mast 212a is affected by a different interference then an antenna associated with mast 212b. Improved communication performance is achieved through analyzing the difference between the signal received by the antenna associated with mast 212a and the signal received by the antenna associated with mast 212b using antenna diversity techniques. The platform may also implement Orthogonal frequency-division multiplexing OFDM or Coded Orthogonal frequency-division multiplexing COFDM or other known communications protocols to reduce noise and interference improving communication performance.

In an alternative embodiment, synchronization between more than a single electromechanical device to improve vantage point of a bilateral platform can be achieved by a pivot connecting between the embodiments.

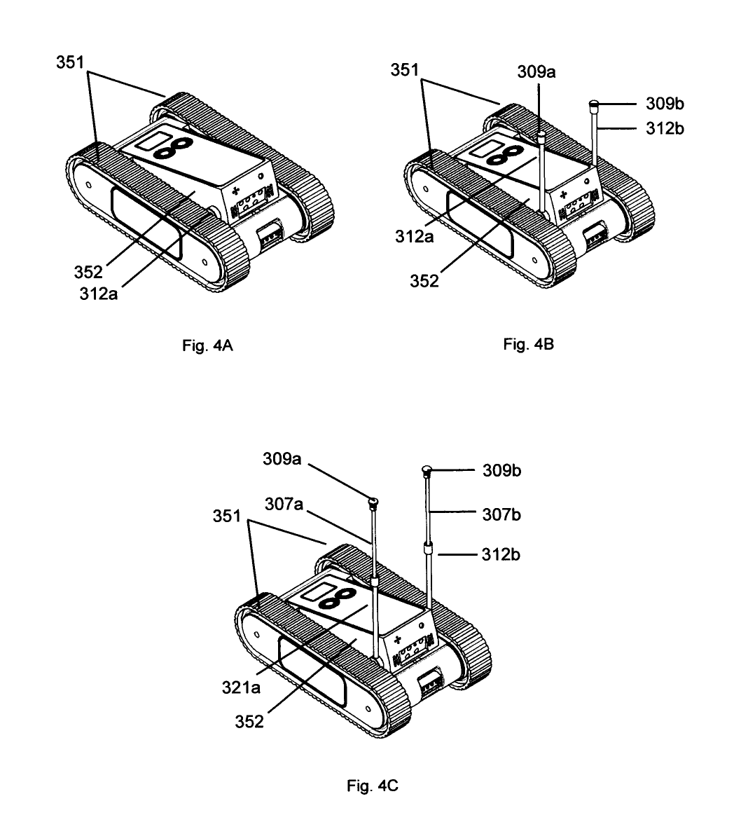

FIG. 4A, 4B and 4C schematically show a perspective view of different operational positions of a dual mast electro-mechanical system for improving viewing perspective of a bilateral robotic platform.

In these figures, the electro-mechanical system for improving viewing perspective is incorporated into a bilateral robotic platform having a frame 351 and an operation assembly 352. Frame 351 includes the chassis of the bilateral robotic platform. Operational assembly 352 includes synchronized operational means and designation means and tilts to either side, depending on the attitude of the bilateral platform. Inclusion of imaging means, designation means and operational means in a synchronized manner into operational assembly 352 may simplify the maneuvering of the robotic platform and the operation of its operational means by a remote operator. Operational assembly 352 can be tilted backwards in order to shift the center of gravity of the robotic platform towards its rear to decrease pressure from the front end of the robotic platform to the ground. Tilting the central assembly also provides double-sided operation of the robotic platform without the need to perform maneuvers which flip the entire robotic platform.

In FIG. 4A, the bilateral robotic platform is illustrated in a transitional mode between an “off mode” (not shown) [wherein operational assembly 352 and embodiments of the electro-mechanical system for improving a vantage point are tilted horizontally and protected inside of frame 351] to an operational mode shown in FIG. 4B, wherein operational assembly 352 and masts 312a, 312b are tilted up above frame 351. In the transitional mode FIG. 4A, mast 312a is only partially visible and mast 312b is not visible.

FIG. 4B depicts the bilateral robotic platform in an operational mode. In the operational mode, masts 312a and 312b are inclined vertically with respect to the ground to give an operator a raised vantage point to view the operational scene. Nevertheless, the masts are not extended fully to avoid danger of fouling, detection by an enemy and instability of sensors 309a,b during motion of the bilateral platform.

FIG. 4C depicts the bilateral robotic platform in an exploring mode. In this exploring mode, masts 312a,b are utilized to gather information from a position superior to that of the sensors which are integral to the bilateral robotic platform and even above the raised position of sensors 309a,b in the operational mode of FIG. 3B. In order to provide a superior viewing angle, an extension mechanism extends two extension poles 307a,b, thereby elevating sensors 309a,b.

Resources mounted in main frame 351 or operational assembly 352 may be integrated with those mounted on masts 312a,b to improve performance of the robotic platform. For example, attitude sensor 227 may be mounted in operational assembly 352. and used to determine how to adjust the inclination of masts 312a,b. The main processor of the robotic platform may be mounted in operational assembly 352 and used to implement communications protocols and determine the optimal inclination of masts 212a,b. Alternatively an antenna may be mounted on main frame 351 and antenna diversity techniques may make use of the differential locations of antennas mounted on masts 212a,b as well as the antenna mounted on main frame 351 to achieve improved reception.

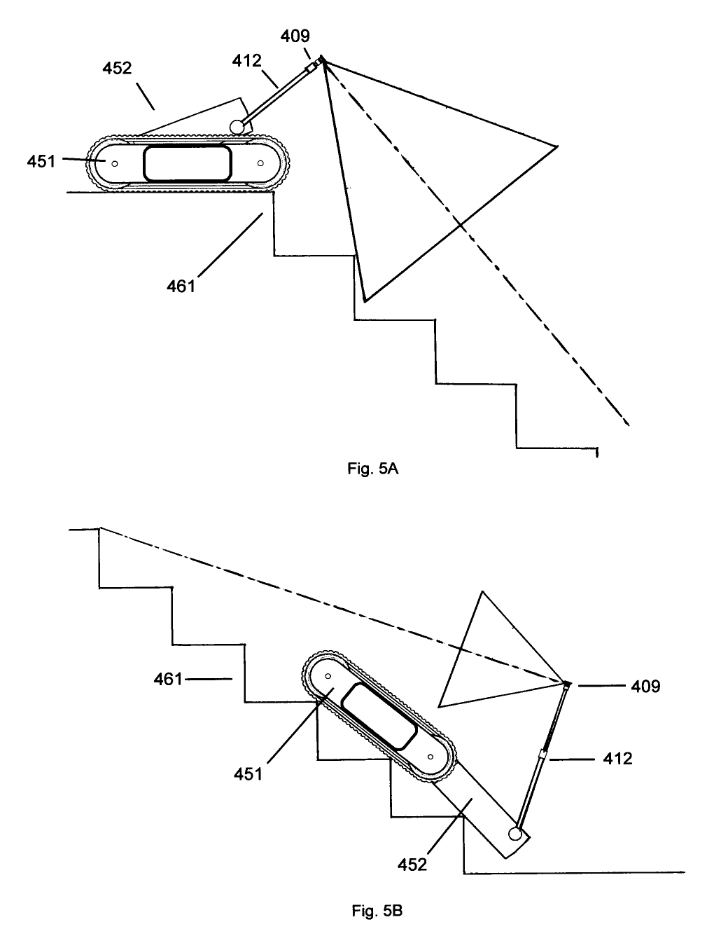

FIG. 5A and 5B schematically show a side projection of a bilateral robotic platform utilizing the inclined electro-mechanism to produce extended operational reconnaissance capabilities.

FIG. 5A depicts a bilateral robotic platform having a frame 451 and an operational assembly 452 approaching the top end of an obstacle in the form of a staircase 461. In order to gather adequate reconnaissance information prior to descending the staircase, the operator of the bilateral robotic platform inclines a mast 412 forward to give an improved vantage point to a sensor 409 in order to acquire information from the staircase area. Sensor 409 may include imaging sensors, microphones, an IR detector, a radiation detector, a biological detector, a motion detector, radar, sonar, an x-ray detector or a heat sensor.

FIG. 5B depicts a bilateral robotic platform having a frame 451 and an operational assembly 452 while descending an obstacle in the form of a staircase 461. In order to acquire adequate reconnaissance information of occurrences and threats behind the platform, mast 412 is extended and inclined backwards to provide an improved vantage point for sensor 409 to achieve situational awareness of the region of interest. In this description, the bilateral robotic platform is designed to extend its length by tilting its operation assembly 452, in order to increase the ability of the bilateral robotic platform to overcome the obstacle.

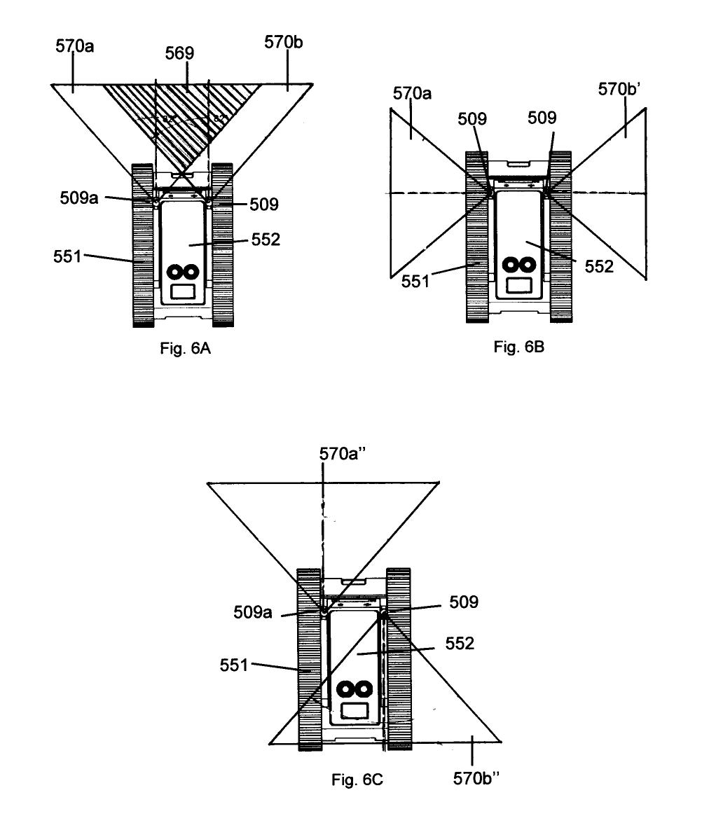

FIG. 6A, 6B, and 6C schematically show a top projection of operational applications which are produced by incorporating directional sensors 509a, b on top of an electro-mechanism.

FIG. 6A displays a bilateral frame 551 and operational assembly 552 and a stereoscopic imaging capability which is produced by incorporating a sensor 509a on a left-side mast (not shown) with a sensor 509b on a right-side mast. Both sensors 509a,b are pointed forward, producing fields of view 570a and 570b respectively in a manner which provides an overlapping field of view 569, in order to enable processing the overlapping images to produce stereoscopic imaging capability, to enhance the situational awareness of a remote operator and therefore to improve his driving operating capabilities over the bilateral robotic platform.

FIG. 6B displays a bilateral frame 551 and operational assembly 552 in a scanning mode which is produced by the rotation of the information gathering sensors 509a,b which are installed on top of masts (not shown).

The scanning regions can be allocated between sensors 509a,b, such that each sensor 509a,b is directed towards a certain region of interest at the operational scene. In FIG. 6B sensor 509a incorporated on the left investigates a field of view 570a′ and the sensors incorporated on the right section investigate the right field of view 570b′.

FIG. 6C depicts another operational configuration of a bilateral frame 551 and operational assembly 552 in which left sensor 509a is rotating to provide a changing field of view 570a″ with frequent coverage of the entire operational scene, while right sensor 509b remains fixed, producing a fixed field of view 570b″ towards a region of particular interest at the operational scene.

In an alternate operational configuration, synchronized rotation of both imaging sensors provides stereoscopic imaging of the scene towards which both imaging sensors are facing.

Alternatively, additional sensors may be incorporated on top of the masts such as microphones and Nuclear, Biological, Chemical (NBC) based detectors. The exact configuration of the information gathering means which are installed on top of the masts may vary in accordance with the operational requirements.

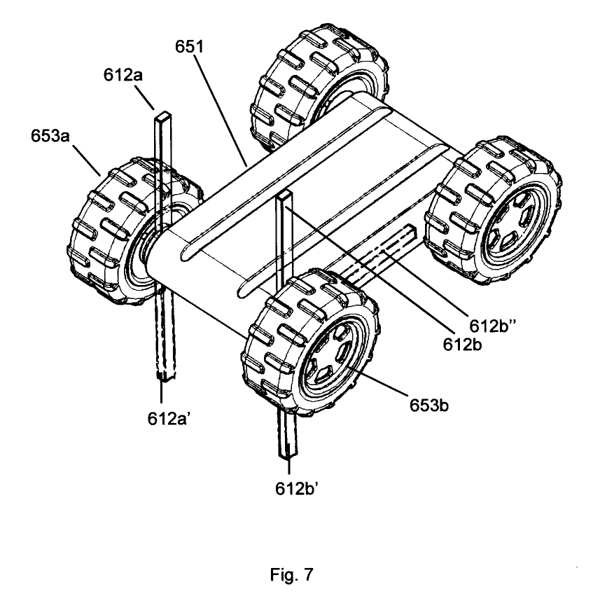

FIG. 7 schematically shows a perspective view of different operational positions of dual electro-mechanism for improving a vantage point incorporated in another kind of a bilateral robotic platform. The robotic platform of FIG. 7 operates based on a symmetric configuration along with firmware techniques, for example, as described above with reference to international application WO/2008135978 to Gal. As such, the main body of the platform consists of a single main frame 651.

The electro mechanism for improving a vantage point includes two masts 612a and 612b which are configured to be inclinable over a full three hundred sixty degrees (alternatively masts 612a,b may be only adjustable over 180 degrees or they may have only three positions with respect to frame 651: 0 degrees sleep mode (parallel to frame 651) for storage and protection by frame 651 or straight up at 90 degrees for right-side-up operation or at a −90 degree angle for upside-down operation). Masts 612a,b are installed between the frame 612 and wheels 653a and 653b.

During the operational of the bilateral robotic platform, masts 612a,b stand vertical in an upright position with respect to the ground. Should the bilateral robotic platform inadvertently flip over, masts 612a,b will automatically reverse their inclination to the opposite direction with respect to frame 651 (as shown by the dashed outlines) of masts 612a′ and 612b′ to ensure that an antenna and sensors (not shown) remains in an upright position with respect to the new side on which the bilateral robotic platform operates.

When the bilateral robotic platform is stowed until the next assignment, masts 612a,b are tilted parallel to frame 651 to decrease the overall volume of the bilateral robotic platform and to protect masts 612a,b. Mast 612b is shown in its stowed position as dotted lines of mast 612b″.

In an alternate embodiment masts 512a,b are flexible and thereby can flex and allow the bilateral platform to flex and avoid damage or entrapment due to obstacles.

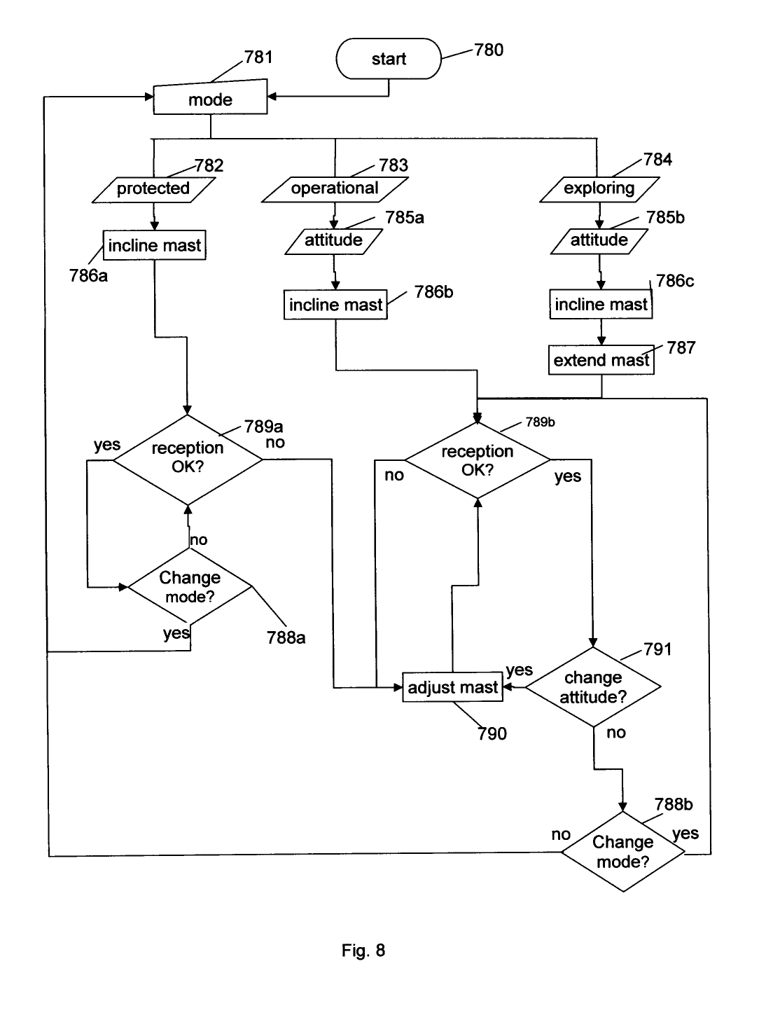

FIG. 8 is a flow chart illustrating a method of extending the capability of a bilateral robotic platform. The method starts 780 by receiving a command to set a new mode 781 of a bilateral robotic platform. If new mode 781 is the protected (sleep) mode 782 then masts 312a,b are inclined 786a and more particularly masts 312a,b are retracted into the protected position between main frame 351 and operational assembly 352

During sleep mode communication performance is periodically tested 789a. If performance is OK then masts 312a,b remain in the same position until the mode is changed 788a or the receptions is tested 789a and found not OK. If communication performance is tested 789a and found to be not OK then masts 312a,b are adjusted 790 and reception is again tested 789b in a feedback loop until the communication performance is found to be OK. More specifically, if masts 312a,b are not in their protected position and reception is very strong in sleep mode then masts 312a,b are adjusted 790 by retracting masts 312a,b into their protected position between main frame 351 and operation assembly 352. On the other hand, if reception is tested 789b and found to be too weak than masts 312a,b are adjusted 790 to provide improved reception (for example adjusting 790 may include changing the angle of inclination and extending masts 312a,b).

Similarly, if masts 312a,b are not in their protected positions and a change in attitude of operational assembly 352 is detected 791 by attitude sensor 227 then masts 312a,b are adjusted in order to counteract the change in attitude and preserve the angle between masts 312a,b and the ground. For example, when an attitude change is detected 791 by ten degrees backwards while climbing a hill, then masts 312a,b are adjusting 790 by inclining ten degrees forward.

When a command is received to change 788a,b a mode of the platform then the new mode 781 is chosen. If new mode 781 is operational mode 783 then the attitude 785a of operational assembly 351 is determined (for example by attitude sensor 227) and masts 312a,b are inclined 786b upward. Then communication performance is periodically tested 789b and the angle of masts 312a,b is adjusted 790 based on a feed-back loop until performance is OK.

When a command is received to change 788a,b a mode of the platform then the new mode 781 is chosen. If new mode 781 is exploring mode 784 then the attitude 785b of operational assembly 351 is determined (for example by attitude sensor 227) and mast 312a,b are inclined 786c upward and extended 787. Then communication performance is periodically tested 789b and the angle of masts 312a,b is adjusted 790 based on a feed-back loop until performance is OK.

What is claimed is:

1. A device for communication of a bilateral robotic platform comprising:
a) a mast configured for inclining over a range of at least 180 degrees with respect to a frame of the bilateral robotic platform;
b) an antenna for receiving a control signal, and
c) an attitude sensor for sensing an attitude of said frame;
wherein said inclining is according to an output from said attitude sensor, said inclining for raising said antenna and wherein said mast is configured for adjusting said inclining in response to a change in said attitude.

2. The device of claim 1, further comprising:
d) an environmental sensor mounted on said mast.

3. The device of claim 2, wherein said environmental sensor includes at least one apparatus selected from the group consisting of an imaging sensor, a light source, a microphone, a light detector, a Global Positioning System (GPS) receiver, a range detector, a laser designator, a directional antenna, and an omni-directional antenna.

5. The device of claim 2, wherein said antenna includes at least one apparatus selected from the group consisting of a radio antenna, a microwave antenna, an infrared signal detector, an ultraviolet signals detector, a directional antenna, and an omni-directional antenna.

6. The device of claim 2 wherein said mast is further configured for adjusting said inclining to optimize a reception of said antenna.

7. A device for extending a capability of a bilateral robotic platform comprising:
a) a mast configured for over inclining over a range of at least 180 degrees with respect to a frame of the bilateral robotic platform;
b) a first environmental sensor, and
c) an attitude sensor for sensing an attitude of said frame;
wherein said inclining is according to an output from said attitude sensor, said inclining raises said first environmental sensor and wherein said mast is configured for adjusting said inclining in response to a change in said attitude.

8. The device of claim 7, wherein at least a portion of said mast is flexible.

9. The device of claim 7, wherein said attitude sensor includes at least one apparatus selected from the group consisting of a tilt detector, an inclinometer, a vertical gyro, an acceleration sensor, an inertial sensor, and a magnetometer.

10. The device of claim 7, wherein said mast is extendible.

11. The device of claim 7, further comprising:
d) a second environmental sensor mounted on a second mast;
wherein a field of view of said second environmental sensor overlaps a field of view of said first environmental sensor and wherein said first environmental sensor and said second environmental sensor are configured to provide a stereoscopic image.

12. The device of claim 7, wherein said first environmental sensor is configured for scanning a region.

13. The device of claim 7, wherein said first environmental sensor includes at least one apparatus selected from the group consisting of an imaging sensor, a light source, a microphone, a light detector, a Global Positioning System (GPS) receiver, a range detector, a laser designator, a directional antenna, and an omni-directional antenna.

14. The device of claim 7, further comprising:
d) an antenna configured for receiving control signals.

15. The device of claim 14, wherein said antenna is integrated into a casing of said mast.

16. The device of claim 14, wherein said mast is configured for adjusting said inclining to optimize a radio reception.

17. The device of claim 7, wherein an interface between said first environmental sensor and said frame includes at least one apparatus selected from the group consisting of a wireless communication device and a slip ring.

18. A method for extending a capability of a bilateral robotic platform comprising the steps of:
a) determining an attitude of a frame of the bilateral robotic platform using an attitude sensor;
b) inclining a mast to raise an environmental sensor, said inclining in accordance with an output of said attitude sensor, and
c) adjusting said inclining according to a change in said attitude.

19. The method of claim 18, wherein said inclining is to an upright position with respect to an environmental reference.

20. The method of claim 18, wherein said inclining is to an upright position with respect to said frame.

21. The method of claim 18, wherein said inclining is adjusted to optimize a radio reception.
